(19) United States
(12) Patent Application Publication
(10) Pub. No.: US 2014/0143885 A1
(43) Pub. Date: May 22, 2014

(54) FIRMWARE-IMPLEMENTED SOFTWARE LICENSING

(71) Applicant: ATI TECHNOLOGIES ULC, Markham (CA)

(72) Inventors: Sergey BLOTSKY, Etobicoke (CA); Kathirkamanathan Nadarajah, Richmond Hill (CA); Jianfei Ye, Richmond Hill (CA); Xing Yue Zhang, Markham (CA)

(73) Assignee: ATI Technologies ULC, Markham (CA)

(21) Appl. No.: 13/681,861

(22) Filed: Nov. 20, 2012

(51) Int. Cl. G06F 21/12

(52) U.S. Cl. CPC G06F 21/121
USPC 726/27

(57) ABSTRACT

A device receives a request to use a software program, determines a comparison indicator based on receiving the request, and determines whether a license for the software program is valid based on a license validity indicator, stored in a secure environment, and the comparison indicator. The device permits execution of secure code stored in the secure environment when the license is determined to be valid, and prevents execution of the secure code stored in the secure environment when the license is determined to be invalid.

### TECHNICAL FIELD

The disclosed embodiments relate generally to software licensing. In particular, the disclosed embodiments relate to implementing software licensing techniques using firmware.

### BACKGROUND

A software license is a legal instrument governing the use or redistribution of copyright-protected software. A typical software license grants an end user permission to use one or more copies of software in ways where such a use would otherwise potentially constitute infringement of the software owner's exclusive rights under copyright law. A software license may be enforced using a computing device.

### SUMMARY OF EMBODIMENTS

According to some embodiments, a device receives a request to use a software program, determines a comparison indicator based on receiving the request, and determines whether a license for the software program is valid based on a license validity indicator, stored in a secure environment, and the comparison indicator. The device permits execution of secure code stored in the secure environment when the license is determined to be valid, and prevents execution of the secure code stored in the secure environment when the license is determined to be invalid.

### BRIEF DESCRIPTION OF THE DRAWINGS

FIGS. 1A and 1B are diagrams of an overview of a software licensing process, according to some embodiments;

FIG. 2 is a diagram of an example computing device that may implement a software licensing process, according to some embodiments;

FIG. 3 is a diagram of example components, of a device, that correspond to one or more components and/or devices of FIG. 2, according to some embodiments;

FIG. 4 is a diagram of example functional components that correspond to one or more components and/or devices of FIG. 2, according to some embodiments;

FIG. 5 is a flow chart of an example process for evaluating and enforcing a software license, according to some embodiments; and

FIGS. 6-9 are diagrams of example embodiments relating to the example process shown in FIG. 5.

### DETAILED DESCRIPTION OF EXAMPLE EMBODIMENTS

The following detailed description of example embodiments refers to the accompanying drawings. The same reference numbers in different drawings may identify the same or similar elements.

A software license governs the use or redistribution of software (e.g., patent-protected software and/or copyright-protected software). Software license enforcement techniques include software-implemented enforcement techniques, hardware-implemented enforcement techniques, and server-implemented enforcement techniques. Software-implemented enforcement techniques consume significant amounts of computer resources, degrade software performance, and are easily circumvented by hackers. Hardware-implemented enforcement techniques require additional hardware, which may be expensive and inconvenient. Server-implemented enforcement techniques require an Internet connection, which may not be available.

Embodiments described herein provide a firmware-implemented license enforcement technique that eliminates many of the issues associated with software-implemented techniques, hardware-implemented techniques, and server-implemented techniques. For example, firmware-implemented enforcement techniques provide high levels of security, are not easily circumvented, do not require additional hardware, and do not require an Internet connection.

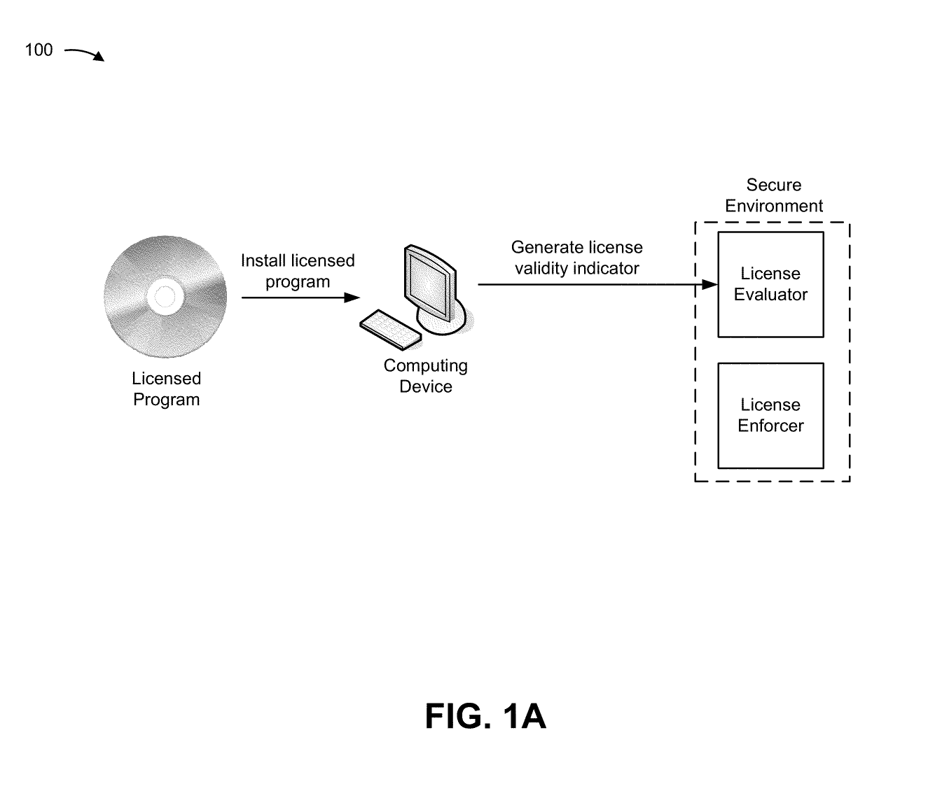

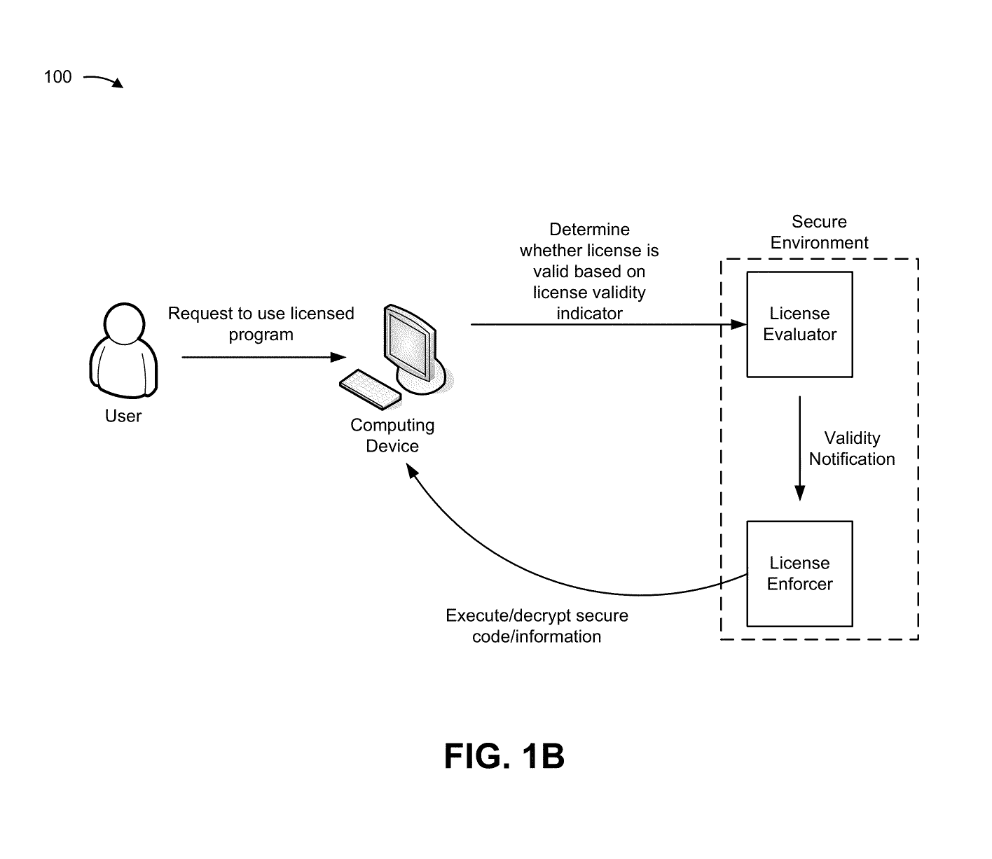

FIGS. 1A and 1B are diagrams of an overview of a software licensing process 100, according to some embodiments. As shown in FIG. 1A, software licensing process 100 includes a licensed program, a computing device, and a secure environment that includes a license evaluator and a license enforcer. In software licensing process 100, the licensed program is a software program, the computing device is a computer, the secure environment includes firmware included in the computing device, and the license evaluator and license enforcer are components of the secure environment.

In some embodiments, the computing device includes a system-on-a-chip (SoC) including one or more processor cores (e.g., central processing unit cores, graphics processing unit cores, etc.) and dedicated hardware (e.g., a dedicated security processor) to implement the secure environment. In some embodiments, the computing device includes a system-on-a-chip (SoC) including one or more processor cores (e.g., central processing unit cores, graphics processing unit cores, etc.) and a hardware-based access control mechanism. In these embodiments, the SoC implements two or more virtual processors including at least one virtual security processor that implements a secure environment and at least one virtual standard processor that does not implement a secure environment (herein referred to as a “non-secure environment”). The hardware-based access control mechanism manages (or otherwise controls) access to the virtual security processor (e.g., the secure environment). For example, the hardware-based access control mechanism may notify applications, peripherals, etc., when a world switch to and from a secure environment has occurred and may enforce security policies in the secure environment or the non-secure environment. The two or more virtual processors utilize resources (e.g., the central processing unit cores, the graphics processing unit cores, etc.) of the SoC. In other words, in these embodiments, the SoC does not include dedicated hardware (e.g., a dedicated security processor) that implements the secure environment.

As shown in FIG. 1A, the licensed program is installed on the computing device. The computing device generates a license validity indicator, which is sent to the license evaluator and stored in the secure environment (e.g., in secure memory, such as non-volatile memory). In some embodiments, the license validity indicator is based on a license key used to install/execute the licensed program and a system identifier associated with the computing device. In some embodiments, the license validity indicator is based on a system time measured when the licensed program is installed on the computing device. System time refers to a computer's (e.g., computing device 210) indication of the passage of time. For example, system time may be measured by a system clock of computing device 210, which counts a number of ticks that have passed since a particular starting date/time. System time may also refer to a conversion of system time to standard calendar time.

As shown in FIG. 1B, a user of the computing device requests to use the licensed program. The computing device determines whether a license for the licensed program is valid, based on the license validity indicator stored by the license evaluator in the secure environment. Upon determining that the license is valid, the license evaluator sends a validity notification to the license enforcer. Based on determining that the license is valid (e.g., via the validity notification), the license enforcer executes secure code (e.g., installed and or executed by the computing device in the secure environment), or decrypts secure code and/or information (e.g., using a decryption algorithm stored and/or executed in the secure environment). The execution and/or decryption allows an essential function of the licensed program to be performed by the computing device.

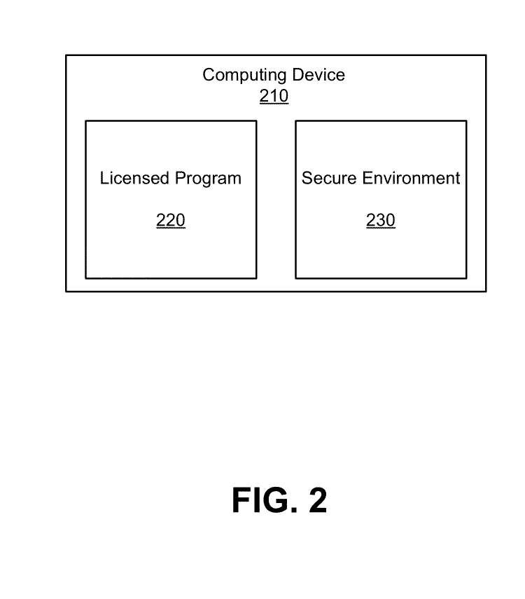

FIG. 2 is a diagram of an example computing device 210 that may implement a software licensing process, according to some embodiments. As shown in FIG. 2, computing device 210 includes a licensed program 220 and a secure environment 230.

Computing device 210 includes a computing device capable of executing a software program and storing information in memory. For example, computing device 210 may include a desktop computer, a laptop computer, a tablet computer, a server computer, a mobile phone, or another computing device capable of executing software and storing information.

Licensed program 220 includes a computer program capable of being executed by a computing device, such as computing device 210. For example, licensed program 220 may include a software program and/or an application, such as a photo/video editor, a photo/video viewer, a file archiver, a music player, a game, a business application (e.g., a word processor, a spreadsheet program, etc.), etc. Licensed program 220 is associated with a license that must be validated before licensed program 220 can be executed by computing device 210. In some embodiments, licensed program 220 is installed on and stored by computing device 210 in a non-volatile memory (e.g., a storage device such as a hard disk drive, a solid state disk drive, etc.).

Secure environment 230 includes a memory that stores information and/or instructions for use by computing device 210. In some embodiments, secure environment 230 includes non-volatile memory that retains stored information when not powered on (e.g., when secure environment 230 and/or computing device 210 is not powered on), such as read-only memory (ROM), erasable programmable read only memory (EPROM), flash memory, a hard drive, or the like. Secure environment 230 may also include firmware, such as a combination of non-volatile memory and the program code and/or information stored in the non-volatile memory. Additionally, or alternatively, secure environment 230 includes firmware running on a dedicated security processor. In some embodiments, secure environment 230 is integrated into a secure execution environment, such as a secure asset management unit (SAMU) environment integrated into a processor. In some embodiments, secure environment 230 is implemented as at least one virtual security processor, as described herein.

The number of devices/components shown in FIG. 2 is provided for explanatory purposes. In practice, there may be additional devices/components, fewer devices/components, different devices/components, or differently arranged devices/components than those shown in FIG. 2. Furthermore, two or more devices/components shown in FIG. 2 may be implemented within a single device/component, or a single device/component shown in FIG. 2 may be implemented as multiple, distributed devices/components. Additionally, one or more of the devices/components shown in FIG. 2 may perform one or more functions described as being performed by another one or more devices/components shown in FIG. 2. Devices/components shown in FIG. 2 may interconnect via wired connections, wireless connections, or a combination of wired and wireless connections.

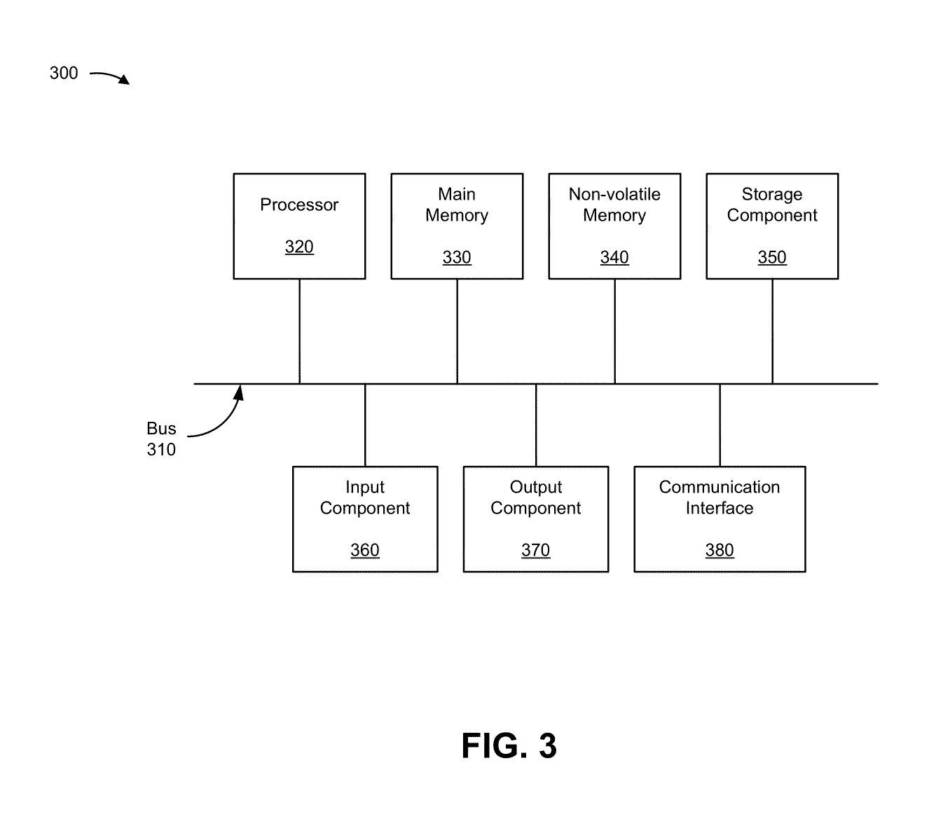

FIG. 3 is a diagram of example components, of a device 300, that correspond to one or more components and/or devices of FIG. 2. As shown in FIG. 3, device 300 includes a bus 310, a processor 320, a main memory 330, a non-volatile memory 340, a storage component 350, an input component 360, an output component 370, and a communication interface 380.

Bus 310 includes a path that permits communication among the components of device 300. Processor 320 includes a processing device (e.g., one or more central processing unit cores, one or more graphics processing unit cores, one or more accelerated processing units, application-specific integrated circuits, digital signal processors, etc.) that interprets and/or executes instructions. In some embodiments, processor 320 includes one or more processor cores. Additionally, or alternatively, processor 320 may include a combination of processing units (e.g., one or more central processing unit cores and one or more graphics processing unit cores, etc.).

Main memory 330 includes one or more random access memories (RAMs) or other types of dynamic and/or volatile storage devices that store information and instructions for execution by processor 320. Non-volatile memory 340 includes one or more ROM components or other types of static and/or non-volatile storage devices that store static information and/or instructions for use by processor 320. In some embodiments, non-volatile memory 340 is included in secure environment 230. Storage component 350 includes a magnetic and/or optical recording medium and a corresponding storage drive.

Input component 360 includes a component that permits a user to input information to device 300 (e.g., a keyboard, a keypad, a mouse, a button, a switch, etc.). Output component 370 includes a component that outputs information from device 300 (e.g., a display, a speaker, one or more light-emitting diodes (“LEDs”), etc.).

Communication interface 380 includes a transceiver-like component, such as a transceiver and/or a separate receiver and transmitter, that enables device 300 to communicate with other devices, such as via a wired connection, a wireless connection, or a combination of wired and wireless connections. For example, communication interface 380 may include an Ethernet interface, an optical interface, a coaxial interface, an infrared interface, a radio frequency (“RF”) interface, a universal serial bus (“USB”) interface, or the like.

Device 300 is described herein as performing various operations. Device 300 may perform these operations in response to processor 320 executing software instructions included in a computer-readable medium, such as main memory 330, non-volatile memory 340, and/or storage component 350. A computer-readable medium may be defined as a non-transitory memory device. A memory device includes space within a single storage device or space spread across multiple storage devices.

In some embodiments, software instructions are read into main memory 330 and/or non-volatile memory 340 from another computer-readable medium or from another device via communication interface 380. When executed, the software instructions stored in main memory 330 and/or non-volatile memory 340 cause processor 320 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software.

The number of components shown in FIG. 3 is provided for explanatory purposes. In practice, device 300 may include additional components, fewer components, different components, or differently arranged components than those shown in FIG. 3. Additionally, or alternatively, computing device 210 may include one or more devices 300 and/or one or more components of device 300.

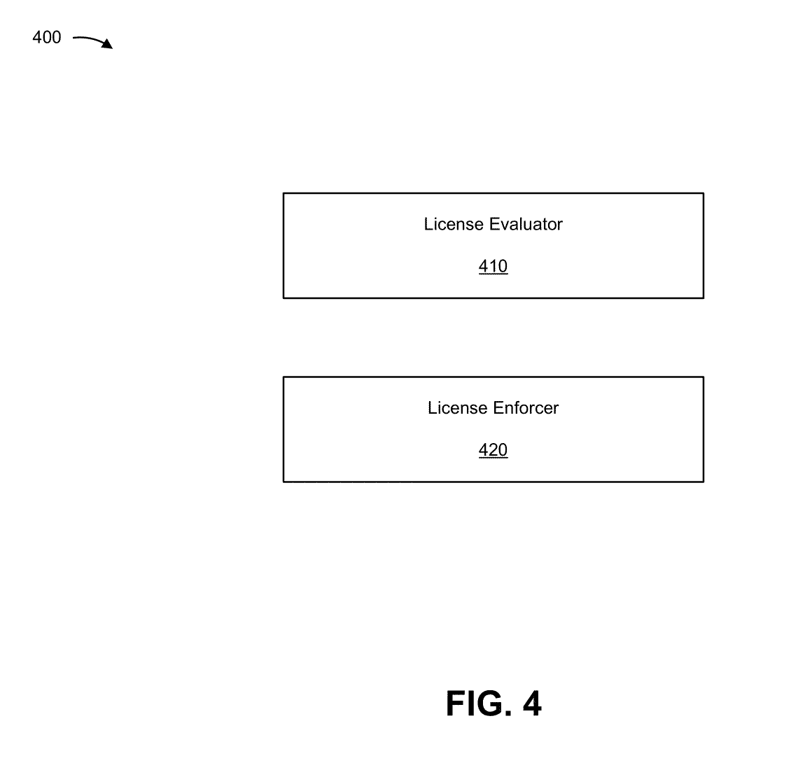

FIG. 4 is a diagram of example functional components 400 that correspond to one or more components and/or devices of FIG. 2. In some embodiments, functional components 400 are included in computing device 210 and/or secure environment 230. In some embodiments, functional components are included in one or more devices, separate from or including computing device 210. As shown in FIG. 4, functional components 400 include license evaluator 410 and license enforcer 420.

License evaluator 410 performs operations associated with evaluating a software license to determine whether the software license is valid. In some embodiments, license evaluator 410 generates, receives, and/or stores a license validity indicator when licensed program 220 is installed by computing device 210. Additionally, or alternatively, license evaluator 410 determines whether a software license is valid, based on the license validity indicator, when computing device 210 receives a request to use licensed program 220. License evaluator 410 may transmit a validity notification, to license enforcer 420, that indicates whether the license is valid. In some embodiments, license evaluator 410 includes dedicated hardware (e.g., at least a portion of a dedicated security processor). In some embodiments, license evaluator 410 includes instructions (e.g., software, firmware, etc.) that are executed in a secure environment (e.g., instructions executed by a dedicated security processor, instructions executed by a virtual security processor, etc.).

License enforcer 420 performs operations associated with enforcing a software license. In some embodiments, license enforcer 420 may receive a validity notification, from license evaluator 410, indicating that a license is valid. If the validity notification indicates that the license is valid, license enforcer 420 executes secure code (e.g., installed by the computing device in the secure environment), or decrypts secure code and/or information (e.g., using a decryption algorithm stored in the secure environment). The execution and/or decryption allows an essential function of licensed program 220 to be performed by computing device 210. If the validity notification indicates that the license is not valid, license enforcer 420 does not execute secure code, or does not decrypt secure code and/or information. In some embodiments, license enforcer 420 includes dedicated hardware (e.g., at least a portion of a dedicated security processor). In some embodiments, license enforcer 420 includes instructions (e.g., software, firmware, etc.) that are executed in a secure environment (e.g., instructions executed by a dedicated security processor, instructions executed by a virtual security processor, etc.).

The number of functional components shown in FIG. 4 is provided for explanatory purposes. In practice, functional components 400 may include additional functional components, fewer functional components, different functional components, or differently arranged functional components than those shown in FIG. 4.

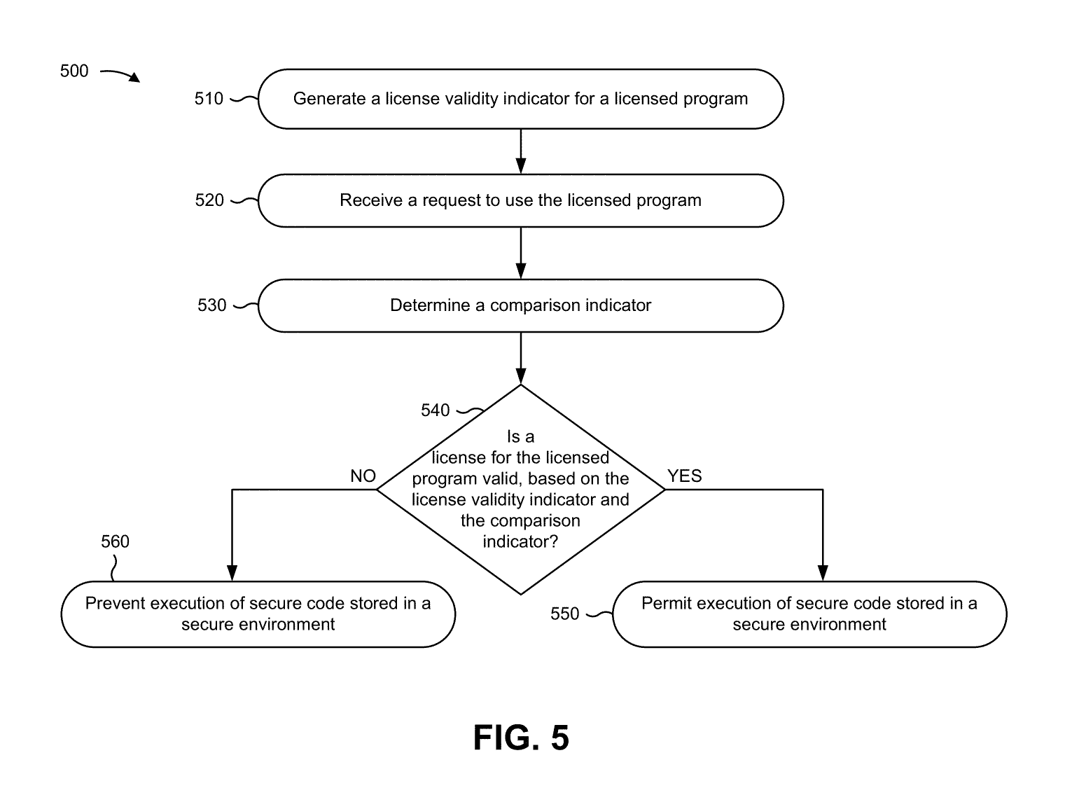

FIG. 5 is a flow chart of an example process 500 for evaluating and enforcing a software license. In some embodiments, one or more process blocks of FIG. 5 are performed by computing device 210. Additionally, or alternatively, one or more process blocks of FIG. 5 are performed by another device or a group of devices separate from or including computing device 210.

As shown in FIG. 5, process 500 includes generating a license validity indicator for a licensed program (block 510). In some embodiments, the license validity indicator is generated when licensed program 220 is installed by computing device 210. The license validity indicator may include a secure key and/or a system time determined when licensed program 220 is being installed and/or has finished installing on computing device 210.

In some embodiments, computing device 210 generates a secure key based on the installation of licensed program 220. Computing device 210 may generate the secure key based on receiving an indication that a user has purchased a license key that permits use of licensed program 220. Computing device 210 generates the secure key using the license key and a system identifier associated with computing device 210. In some embodiments, computing device 210 combines the license key and the system identifier, according to a key-generation algorithm, to generate the secure key. Computing device 210 stores the secure key in secure environment 230 (e.g., in license evaluator 410). In some embodiments, computing device 210 stores the secure key in a secure environment associated with a dedicated security processor and/or a virtual security processor. Alternatively, computing device 210 stores the secure key outside of secure environment 230 (e.g., in a non-secure storage area of storage component 350). In this embodiment, computing device 210 may mark the secure key as secure, and may only permit access to the secure key by a dedicated security processor and/or a virtual security processor.

The license key includes, in some embodiments, a combination of characters (e.g., letters, numbers, symbols, etc.) that permit access to and/or use of licensed program 220 (and/or to a portion or function of licensed program 220). The system identifier includes, in some embodiments, a unique identifier associated with computing device 210, such as a serial number or another unique identifier that identifies computing device 210 and/or a component of computing device 210 (e.g., a processor serial number, a motherboard serial number, a serial number of another component of computing device 210, such as the components depicted in FIG. 2 or 3, etc.). In some embodiments, the system identifier may include a combination of multiple identifiers associated with computing device 210.

In some embodiments, computing device 210 stores the system time, determined when licensed program 220 is installed on computing device 210, in secure environment 230 (e.g., in license evaluator 410). In some embodiments, computing device 210 stores the system time in a secure environment associated with a dedicated security processor and/or a virtual security processor. Alternatively, computing device 210 stores the system time outside of secure environment 230 (e.g., in a non-secure storage area of storage component 350). In this embodiment, computing device 210 may mark the system time as secure, and may only permit access to the system time by a dedicated security processor and/or a virtual security processor. Computing device 210 may store the system time based on receiving an indication that a license to use licensed program 220 expires after a particular amount of time has passed (e.g., a 30-day trial period).

As further shown in FIG. 5, process 500 includes receiving a request to use the licensed program (block 520), determining a comparison indicator (block 530), and determining whether a license for the licensed program is valid, based on the license validity indicator and the comparison indicator (block 540). In some embodiments, computing device 210 receives the request from a user of computing device 210. For example, a user may indicate, via an input component of computing device 210, a desire to execute licensed program 220 and/or a particular function of licensed program 220. Computing device 210 also determines a comparison indicator, and determines whether the license for licensed program 220 is valid by comparing the comparison indicator to the license validity indicator. Computing device 210 may receive the comparison indicator with the request to use licensed program 220, or may retrieve and/or generate the comparison indicator based on receiving the request.

In some embodiments, when the license validity indicator is a secure key, the comparison indicator is a comparison key. In some embodiments, computing device 210 receives and/or retrieves the comparison key (e.g., from the user and/or from memory). In some embodiments, computing device 210 receives a comparison license key (e.g., from the user and/or from memory), and generates the comparison key by combining the comparison license key and the system identifier using the key-generating algorithm. Computing device 210 determines whether the license is valid based on comparing the comparison key to the secure key. If the comparison key matches the secure key, computing device 210 determines that the license is valid. If the comparison key does not match the secure key, computing device 210 determines that the license is not valid.

In some embodiments, when the license validity indicator is the system time, determined when licensed program 220 is installed on computing device 210 (“the system time at installation”), the comparison indicator is a comparison system time, determined when the request to use licensed program 220 is received (“the system time at request”). Computing device 210 determines whether the license is valid by comparing the system time at installation to the system time at request. If the difference in time between the system time at installation and the system time at request is less than a threshold (e.g., is less than a trial period threshold, such as a 30-day trial), computing device 210 determines that the license is valid. If the difference in time between the system time at installation and the system time at request is greater than a threshold, computing device 210 determines that the license is not valid. In some embodiments, computing device 210 determines the threshold time period (e.g., the trial period) from licensed program 220 (e.g., during installation).

If computing device 210 determines that the license is valid (block 540—YES), then process 500 includes permitting execution of secure code stored in a secure environment (block 550). In some embodiments, the secure code is a portion of program code used to run licensed program 220. When computing device 210 installs licensed program 220, a portion of the program code of licensed program 220 may be installed in secure environment 230. Alternatively, computing device 210 may install the portion of the program code outside of secure environment 230 (e.g., in a non-secure storage area of storage component 350). In this embodiment, computing device 210 may mark the installed portion as secure, and may only permit access to and/or execution of the installed portion by a dedicated security processor and/or a virtual security processor. The portion of code installed in secure environment 230 performs an essential function of licensed program 220, such that the essential function cannot be performed unless the license is valid. For example, the essential function may be an algorithm that produces a large amount of data, an algorithm that parses the header of an archive file to determine information about files stored in the archive file, etc. When computing device 210 determines that the license is valid, the portion of code stored in secure environment 230 is executed or permitted to be executed (e.g., by license enforcer 420).

As an example, a software program that compresses and archives files may install program code in secure environment 230. The program code may parse the header of an archived file in secure environment 230, and may send information back to the software program regarding information about the files contained in the archived file, based on the parsed header.

As another example, a software program used to edit images and/or video may install program code, in secure environment 230, that performs a photo/video editing algorithm that produces a large amount of information. Secure environment 230 generates the information and sends it to the software program to edit the photo/video. Generating a large amount of information in secure environment 230 ensures that simple hacks cannot circumvent the enforcement mechanisms of secure environment 230. Furthermore, execution of software functionality in secure environment 230 allows for improvement of confidentiality of secret information embedded into the software program.

In some embodiments, the secure code is a decryption algorithm (e.g., a shared secret key pair, a public key pair, a private key pair, etc.) stored in secure environment 230. When computing device 210 installs licensed program 220, a portion of the program code of licensed program 220 and/or information required to use licensed program 220 is encrypted. When computing device 210 determines that the license is valid, the encrypted code and/or information is decrypted or permitted to be decrypted (e.g., by license enforcer 420) by the decryption algorithm stored (or otherwise executed) in secure environment 230.

If computing device 210 determines that the license is not valid (block 540—NO), then process 500 includes preventing execution of secure code stored in a secure environment (block 560). In some embodiments, when computing device 210 determines that the license is not valid, license enforcer 420 prevents computing device 210 from executing the portion of code stored in secure environment 230. In some embodiments, when computing device 210 determines that the license is not valid, license enforcer 420 prevents computing device 210 from decrypting code and/or information using the decryption algorithm stored in secure environment 230.

While a series of blocks has been described with regard to FIG. 5, the blocks and/or the order of the blocks may be modified in some embodiments. Additionally, or alternatively, non-dependent blocks may be performed in parallel.

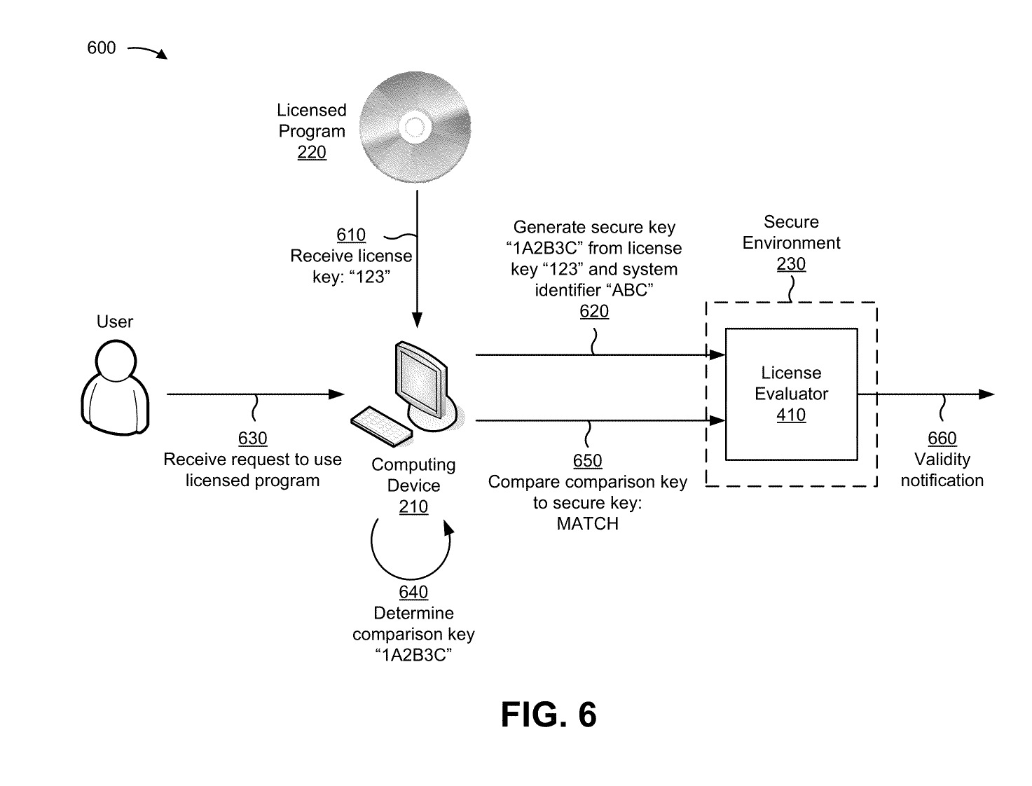

FIG. 6 is a diagram of an example embodiment 600 relating to the example process shown in FIG. 5. FIG. 6 depicts an example embodiment 600 where license evaluator 410 evaluates a software license using a secure key and a comparison key to determine whether the software license is valid.

As shown by reference number 610, example embodiment 600 includes receiving a license key that permits use and/or installation of licensed program 220 on computing device 210. As shown by reference number 620, computing device 210 combines the license key with a system identifier (e.g., a serial number or other device identifier of a component of computing device 210, such as processor 320) to generate a secure key. Computing device 210 generates the secure key by applying a key-generating algorithm to combine the license key and the system identifier. For example, a license key of “123” and a system identifier of “ABC” may be combined to generate a secure key of “1A2B3C.” The secure key is stored in secure environment 230 (e.g., in license evaluator 410).

As shown by reference number 630, computing device 210 receives a request to use licensed program 220. The request may include a request to execute (e.g., run) licensed program 220, and/or a request to execute a particular function of licensed program 220. In some embodiments, the request is generated by a user of computing device 210. In some embodiments, the request is generated by a device and/or a component of a device (e.g., by an application running on computing device 210 and/or another device).

As shown by reference number 640, computing device 210 determines the comparison key. For example, computing device 210 may receive, retrieve, and/or generate the comparison key based on receiving the request. In some embodiments, computing device 210 receives a comparison license key based on the request to use licensed program 220 (e.g., from the user, licensed program 220, and/or memory). Computing device 210 generates the comparison key by applying the key-generating algorithm to the comparison license key and the system identifier.

As shown by reference number 650, computing device 210 compares the comparison key to the secure key to determine whether the license for licensed program 220 is valid. Computing device 210 (e.g., license evaluator 410) generates a validity notification based on the comparison, as shown by reference number 660. The validity notification indicates whether the license is valid or invalid, and may be transmitted to license enforcer 420. For example, if the comparison key and the secure key are both “1A2B3C,” then the validity notification indicates that the license is valid.

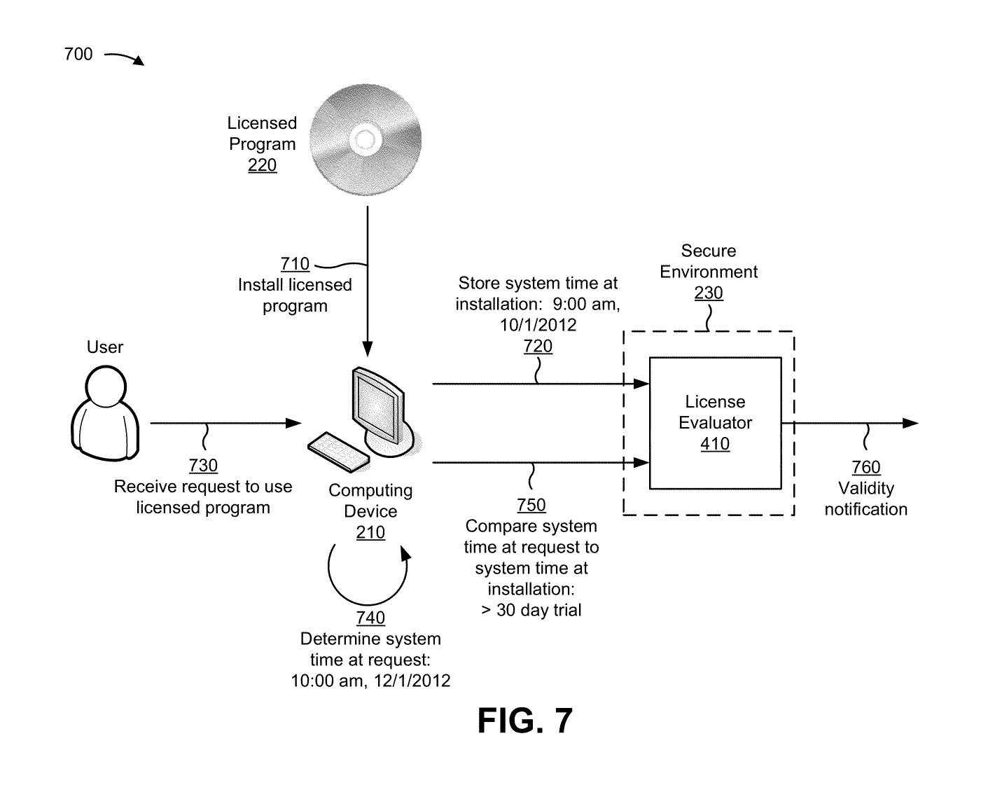

FIG. 7 is a diagram of an example embodiment 700 relating to the example process shown in FIG. 5. FIG. 7 depicts an example embodiment 700 where license evaluator 410 evaluates a software license using system time at installation and a system time at request to determine whether the software license is valid.

As shown by reference number 710, example embodiment 700 includes installing licensed program 220 on computing device 210. As shown by reference number 720, the system time, determined when licensed program 220 is installed on computing device 210, is stored in secure environment 230 (e.g., in license evaluator 410). For example, the system time when licensed program 220 is installed may be 9:00 am on Oct. 1, 2012. When licensed program 220 is installed, computing device 210 may also receive a threshold time value during which a license to use licensed program 220 is valid (e.g., 30 days, or until 9:00 am on Oct. 31, 2012).

As shown by reference number 730, computing device 210 receives a request to use licensed program 220, as described above in connection with FIG. 6. As shown by reference number 740, computing device 210 determines the system time, determined when the request to use licensed program 220 is received. As shown by reference number 750, computing device 210 compares the system time at the time of the request to the system time at the time of installation (e.g., stored in secure environment 230).

Computing device 210 (e.g., license evaluator 410) determines whether the difference between the system time at request and the system time at installation satisfies a threshold, and generates a validity notification based on the difference satisfying a threshold (e.g., the threshold time value received during installation), as shown by reference number 760. For example, if the difference is less than the threshold (e.g., if the system time at request is before 9:00 am on Oct. 31, 2012, for a 30-day trial), the validity notification indicates that the license is valid. If the difference is greater than or equal to the threshold (e.g., if the system time at request is on or after 9:00 am on Oct. 31, 2012), the validity notification indicates that the license is invalid. License evaluator 410 may transmit the validity notification to license enforcer 420.

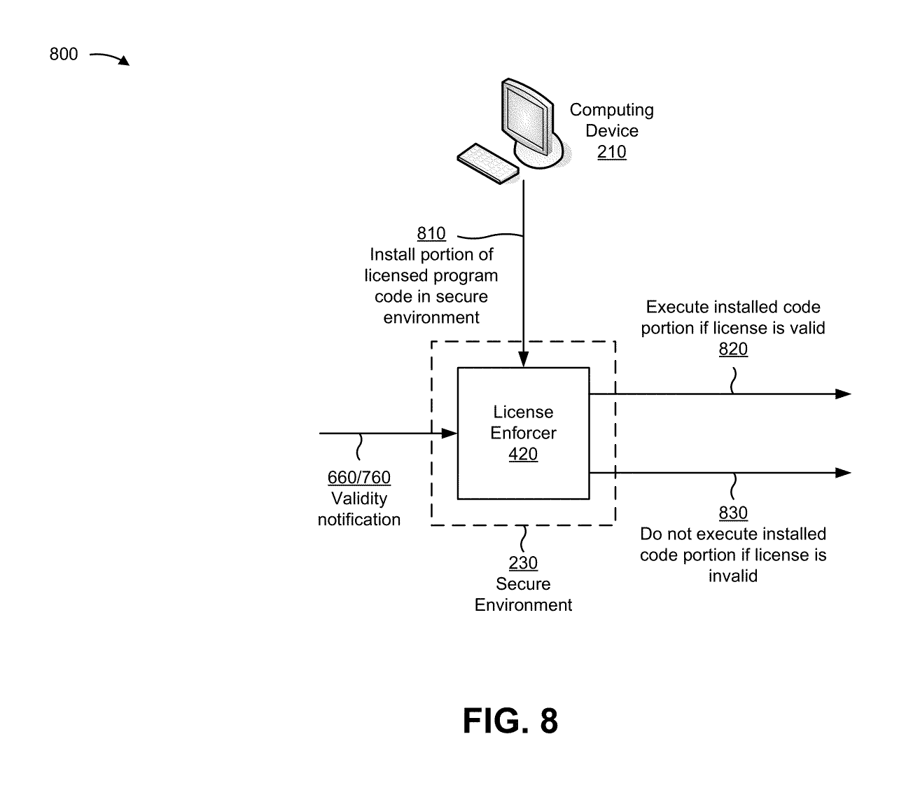

FIG. 8 is a diagram of an example embodiment 800 relating to the example process shown in FIG. 5. FIG. 8 depicts an example embodiment 800 where license enforcer 420 permits or prevents execution of a portion of code of licensed program 220 based on the validity notification.

As shown by reference number 810, computing device 210 installs a portion of the program code of licensed program 220 in secure environment 230 (e.g. in license enforcer 420). In some embodiments, the portion of code executes an essential function of licensed program 220. As further shown in FIG. 8, license enforcer 420 receives validity notification 660/760 (e.g., from license evaluator 410).

As shown by reference number 820, license enforcer 420 executes the installed portion of code if the validity notification indicates that the license for licensed program 220 is valid. As shown by reference number 830, license enforcer 420 does not execute the installed portion of code if the validity notification indicates that the license for licensed program 220 is invalid.

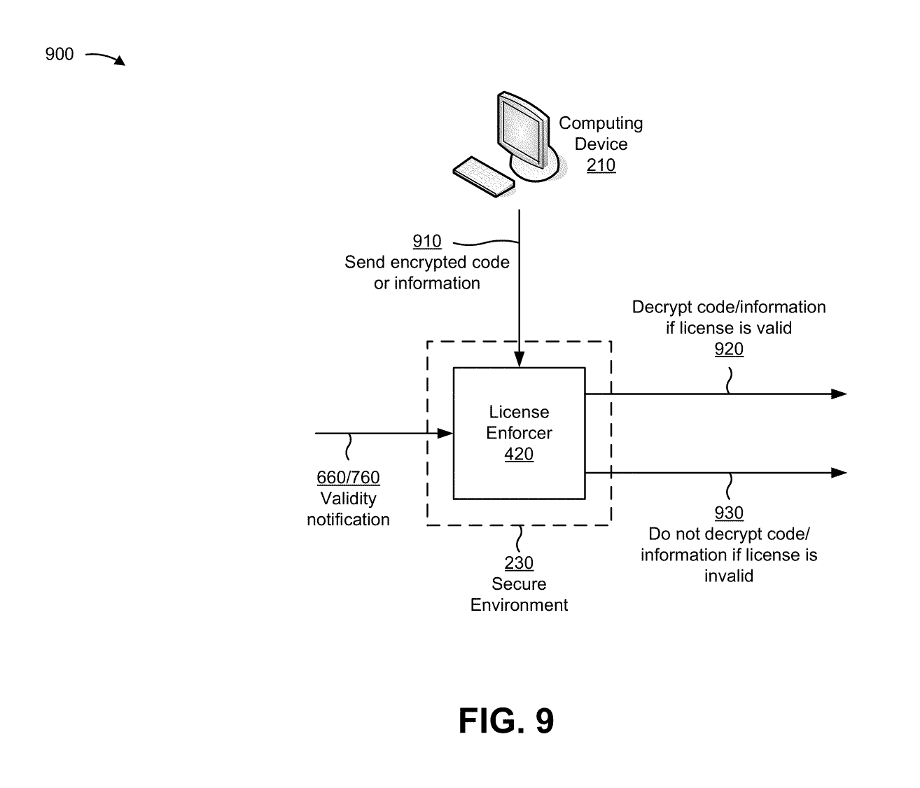

FIG. 9 is a diagram of an example embodiment 900 relating to the example process shown in FIG. 5. FIG. 9 depicts an example embodiment 900 where license enforcer 420 permits or prevents execution of a decryption algorithm based on the validity notification.

As shown by reference number 910, license enforcer 420 receives, from computing device 210, encrypted program code and/or encrypted information required to use licensed program 220. In some embodiments, computing device 210 sends the encrypted code/information to license enforcer 420 based on a user request to use licensed program 220. As further shown in FIG. 9, license enforcer 420 receives validity notification 660/760 (e.g., from license evaluator 410).

As shown by reference number 920, license enforcer 420 decrypts the encrypted code/information, using a decryption algorithm, if the validity notification indicates that the license for licensed program 220 is valid. As shown by reference number 930, license enforcer 420 does not decrypt the encrypted code/information if the validity notification indicates that the license for licensed program 220 is invalid. In some embodiments, computing device 210 sends the decryption algorithm to license enforcer 420, and license enforcer 420 stores the decryption algorithm, when licensed program 220 is installed on computing device 210.

Embodiments described herein provide a firmware-implemented licensing technique that uses a secure environment to improve software license evaluation, verification, and enforcement. For example, firmware-implemented licensing techniques provide high levels of security, are not easily circumvented, do not require additional hardware, and do not require an Internet connection.

The foregoing disclosure provides illustration and description, but is not intended to be exhaustive or to limit the embodiments to the precise form disclosed. Modifications and variations are possible in light of the above disclosure or may be acquired from practice of the embodiments.

As used herein, the term “component” is intended to be broadly construed as hardware, firmware, or a combination of hardware and software.

Some embodiments are described herein in conjunction with thresholds. The term “greater than” (or similar terms), as used herein to describe a relationship of a value to a threshold, may be used interchangeably with the term “greater than or equal to” (or similar terms). Similarly, the term “less than” (or similar terms), as used herein to describe a relationship of a value to a threshold, may be used interchangeably with the term “less than or equal to” (or similar terms). As used herein, “satisfying” a threshold (or similar terms) may be used interchangeably with “being greater than a threshold,” “being greater than or equal to a threshold,” “being less than a threshold,” “being less than or equal to a threshold,” or other similar terms.

It will be apparent that systems and/or methods, as described herein, may be implemented in many different forms of software, firmware, and hardware in the embodiments illustrated in the figures. The actual software code or specialized control hardware used to implement these systems and/or methods is not limiting of the embodiments. Thus, the operation and behavior of the systems and/or methods were described without reference to the specific software code—it being understood that software and control hardware can be designed to implement the systems and/or methods based on the description herein.

Even though particular combinations of features are recited in the claims and/or disclosed in the specification, these combinations are not intended to limit the disclosure of possible embodiments. In fact, many of these features may be combined in ways not specifically recited in the claims and/or disclosed in the specification. Although each dependent claim listed below may directly depend on only one claim, the disclosure of possible embodiments includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Further, the phrase “based on” is intended to mean “based, at least in part, on” unless explicitly stated otherwise.

What is claimed is:

1. A method, comprising:
receiving, by the processor, a request to use a software program;
determining, by the processor and based on receiving the request, a comparison indicator;
determining, by the processor and based on a license validity indicator, stored in a secure environment, and the comparison indicator, whether a license for the software program is valid;
permitting, by the processor and when the license is determined to be valid, execution of secure code stored in the secure environment; and
preventing, by the processor and when the license is determined to be invalid, execution of the secure code stored in the secure environment.

2. The method of claim 1, where the license validity indicator includes a secure key generated by applying a key-generating algorithm to:
a license key used to access the software program, and
a system identifier that identifies at least one component of a device used to run the software program.

3. The method of claim 2, where the comparison indicator includes a comparison key generated by applying the key generating algorithm to:
a comparison license key, and
the system identifier; and
where the determining whether the license is valid further comprises:
determining whether the license is valid by determining whether the comparison key matches the secure key.

4. The method of claim 1, where the license validity indicator indicates a first system time determined when the software program is installed on a computing device.

5. The method of claim 4, where the comparison indicator indicates a second system time determined when the request to use the software program is received by the computing device; and
where the determining whether the license is valid further comprises:
determining whether the license is valid by determining whether a difference between the first system time and the second system time satisfies a threshold.

6. The method of claim 1, where the secure code includes a portion of program code used to run the software program.

7. The method of claim 1, where the secure code includes a decryption algorithm used to decrypt program code or information used to run the software program.

8. A device, comprising:
one or more processors to:
receive a request to use a software program;
determine, based on receiving the request, a comparison indicator;
determine, based on a license validity indicator, stored in a secure environment, and the comparison indicator, whether a license for the software program is valid;
permit, when the license is determined to be valid, execution of secure code stored in the secure environment; and
prevent, when the license is determined to be not valid, execution of the secure code stored in the secure environment.

9. The device of claim 8, where the license validity indicator includes a secure key generated by applying a key-generating algorithm to:
a license key used to access the software program, and
a system identifier that identifies at least one component of a device used to run the software program.

10. The device of claim 9, where the comparison indicator includes a comparison key generated by applying the key generating algorithm to:
a comparison license key, and
the system identifier; and
where the one or more processors, when determining whether the license is valid, are further to:
determine whether the license is valid by determining whether the comparison key matches the secure key.

11. The device of claim 8, where the license validity indicator indicates a first system time determined when the software program is installed on a computing device.

12. The device of claim 11, where the comparison indicator indicates a second system time determined when the request to use the software program is received by the computing device; and
where the one or more processors, when determining whether the license is valid, are further to:
determine whether the license is valid by determining whether a difference between the first system time and the second system time satisfies a threshold.

13. The device of claim 8, where the secure code includes a portion of program code used to run the software program.

14. The device of claim 8, where the secure code includes a decryption algorithm used to decrypt program code or information used to run the software program.

15. A non-transitory computer-readable medium storing instructions, the instructions comprising:
one or more instructions that, when executed by a processor, cause the processor to:
receive a request to use a software program;
determine, based on receiving the request, a comparison indicator;
determine, based on a license validity indicator, stored in a non-volatile memory, and the comparison indicator, whether a license for the software program is valid;
permit, when the license is determined to be valid, execution of secure code stored in the non-volatile memory; and
prevent, when the license is determined to be in valid, execution of the secure code stored in the non-volatile memory.

16. The computer-readable medium of claim 15, where the license validity indicator includes a secure key generated by applying a key-generating algorithm to:
a license key used to access the software program, and
a system identifier that identifies at least one component of a device used to run the software program.

17. The computer-readable medium of claim 16, where the comparison indicator includes a comparison key generated by applying the key generating algorithm to:
a comparison license key, and
the system identifier; and
where the one or more instructions, that cause the processor to determine whether the license is valid, further cause the processor to:
determine whether the license is valid by determining whether the comparison key matches the secure key.

18. The computer-readable medium of claim 15, where the license validity indicator indicates a first system time determined when the software program is installed on a computing device.

19. The computer-readable medium of claim 18, where the comparison indicator indicates a second system time determined when the request to use the software program is received by the computing device; and
where the one or more instructions, that cause the processor to determine whether the license is valid, further cause the processor to:
determine whether the license is valid by determining whether a difference between the first system time and the second system time satisfies a threshold.

20. The computer-readable medium of claim 15, where the secure code includes at least one of:
a portion of program code used to run the software program; or
a decryption algorithm used to decrypt program code or information used to run the software program.
